(19) United States
(12) Patent Application Publication
(10) Pub. No.: US 2024/0401358 A1
(43) Pub. Date: Dec. 5, 2024

(54) POOL CLEANING ROBOT WITH DISPLAY DEVICE

(71) Applicant: SUZHOU SMOROBOT TECHNOLOGY CO., LTD., Suzhou (CN)

(72) Inventor: Jie TANG, Suzhou (CN)

(21) Appl. No.: 18/798,943

(22) Filed: Aug. 9, 2024

Related U.S. Application Data
(63) Continuation of application No. PCT/CN2022/075678, filed on Feb. 9, 2022.

(51) Int. Cl. E04H 4/16; B01D 35/143; C02F 1/00; C02F 103/42

(52) U.S. Cl. CPC E04H 4/1654; B01D 35/143; C02F 1/001; C02F 2103/42; C02F 2201/008; C02F 2209/445

(57) ABSTRACT

Provided is a pool cleaning robot with a display device. The pool cleaning robot with a display device includes a cleaning member for cleaning a pool, a detecting device and a display device. The detecting device is arranged in the cleaning member and configured to detect a state of the cleaning member. The display device is electrically connected to the detecting device and configured to display at least one state information of the cleaning member. The state information includes self-running state information of the cleaning member and/or human-machine interaction state information of the cleaning member.

### FIELD OF THE INVENTION

Embodiments of the present application relate to the technical field of cleaning devices, and particularly to a pool cleaning robot with a display device.

### BACKGROUND OF THE INVENTION

Pool cleaning robot is a kind of cleaning robot produced to facilitate the cleaning of a swimming pool and to save manpower, and is capable of repeatedly cleaning the bottom and the side wall of the pool and filtering the water in the pool. During the working process, the pool cleaning robot moves through drive wheels and uses a roller brush to remove contaminants.

Since the pool cleaning robot works under water, and it takes a long time to complete a cleaning work, the user cannot know status information of the pool cleaning robot during the work process. When the pool cleaning robot fails, the user cannot be alerted in time, resulting in a decrease in the reliability of the pool cleaning robot, or damage to the pool cleaning robot due to failure to troubleshooting in time.

### SUMMARY OF THE INVENTION

In order to solve the above problem, embodiments of the present disclosure provide a pool cleaning robot with a display device to at least partially solve the above problem.

One or more embodiments of the present disclosure provide a pool cleaning robot with a display device. The pool cleaning robot with a display device includes: a cleaning member for cleaning a pool; a detecting device that is arranged in the cleaning member and configured to detect a state of the cleaning member; and a display device. The display device is electrically connected to the detecting device and configured to display at least one state information of the cleaning member. The state information includes human-machine interaction state information and/or self-running state information of the cleaning member of the cleaning member.

In one or more embodiments, the cleaning member includes at least a first housing and a filter structure, the first housing has a water inlet and a water outlet, the filter structure is arranged between the water inlet and the water outlet and configured to filter water entering from the water inlet to remove contaminants, and the water outlet is configured to discharge the filtered water.

In one or more embodiments, the cleaning member further includes a sealed cavity, the sealed cavity includes a sealing housing, the sealing housing is arranged in the first housing, and the detecting device is arranged in the sealing housing. A water pump motor is provided in the sealing housing, an output shaft of the water pump motor extends out of the sealing housing, and the output shaft of the water pump motor is provided with an impeller for driving water to flow. The detecting device is connected to the water pump motor and is configured to detect a current of the water pump motor, the current is used for indicating a clogging degree of the filter structure, and the current is one of the self-running state information of the cleaning member.

In one or more embodiments, a battery is arranged in the sealing housing, the detecting device is connected to the battery and configured to detect remaining power of the battery as one of the self-running state information of the cleaning member.

In one or more embodiments, the first housing is connected to a driving mechanism, a driving motor is provided in the sealed cavity, an output shaft of the driving motor extends out of the sealing housing and is connected to the driving mechanism so as to drive the driving mechanism to move, the detecting device is connected to the driving motor and configured to detect a rotation speed and/or a rotation angle of the driving motor as one or more of the self-running state information of the cleaning member.

In one or more embodiments, the output shaft of the driving motor is connected with an encoder, and the detecting device is connected to the encoder and configured to determine the rotation speed and/or the rotation angle of the driving motor as one or more of the self-running state information of the cleaning member according to an encoding signal provided by the encoder.

In one or more embodiments, the display device includes at least a display unit, and the display unit is configured to display at least one state information.

In one or more embodiments, the display device includes at least one display unit, and the display unit includes a first display part and a second display part. The first display part and the second display part are configured to cooperate to display one state information, or the first display part and the second display part are configured to display different state information at the same time.

In one or more embodiments, the first display part includes a plurality of display lights, the plurality of display lights are arranged on the cleaning member and electrically connected to the detecting device, and at least one of rightness or color of each of the plurality of display lights is adjusted according to a signal received from the detecting device so as to display corresponding state information.

In one or more embodiments, the display unit further includes a display screen. The display screen is arranged on the cleaning member, or the display screen is arranged outside a pool independently of the cleaning member and is in communication connection with the detecting device.

According to embodiments of the present disclosure, the detecting device is provided in the cleaning member, the detecting device is configured to detect state information of the cleaning member, and the state information includes self-running state information of the cleaning member and/or human-computer interaction state information of the cleaning member. The display device is electrically connected with the detecting device, and is configured to display at least one state information of the cleaning member, facilitating the user to view the state information, so that the user can know the state of the pool cleaning robot in time, and adjust the pool cleaning robot or deal with the fault in time.

### BRIEF DESCRIPTION OF DRAWINGS

The following drawings are only intended to illustrate and explain the present disclosure, and should not be constructed to limit the scope of the present disclosure, in which:

FIG. 1 illustrates a three-dimensional exploded view of a pool cleaning robot with a display device according to an embodiment of the present disclosure;

FIG. 2 illustrates a three-dimensional structural schematic diagram of a pool cleaning robot with a display device according to an embodiment of the present disclosure; and

FIG. 3 illustrates a partial front structural schematic diagram of a display device of a pool cleaning robot with a display device according to an embodiment of the present disclosure.

### LIST OF REFERENCE NUMERALS

10 cleaning member; 11 first housing; 111 water inlet; 112 water outlet; 12 filter structure; 13 sealed cavity; 131 sealing housing; 132 water pump motor; 133 impeller; 22 driving wheel; 23 driven wheel; 30 display device; 31 first display part; 311 display light; 32 second display part; 40 driving mechanism.

### DETAILED DESCRIPTION OF THE INVENTION

In order to more clearly understand technical characters, objectives, and effects of embodiments of the present disclosure, specific implementation of the present disclosure is illustrated with reference to accompanying drawings.

The word “exemplary” is used herein to mean “serving as an example, instance, or illustration.” Any drawing or implementation described herein as “exemplary” should not be construed as a more preferred or advantageous technical solution.

To make the drawings appear uncluttered, only those parts relevant to the present disclosure are shown schematically in the drawings, and they do not represent the actual structure thereof as a product. Furthermore, to make the drawings appear uncluttered for ease of understanding, in the case of components having the same structure or function in certain drawings, only one or more of these are drawn schematically, or only one or more are marked.

A pool cleaning robot includes a cleaning member 10, a detecting device and a display device 30.

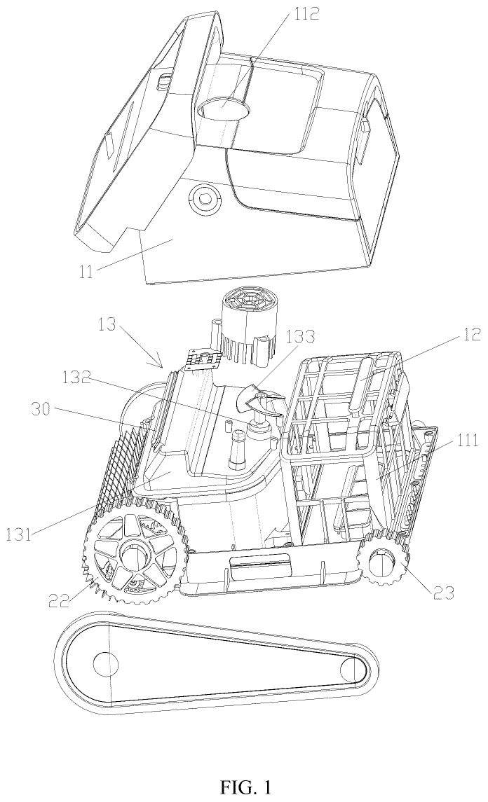

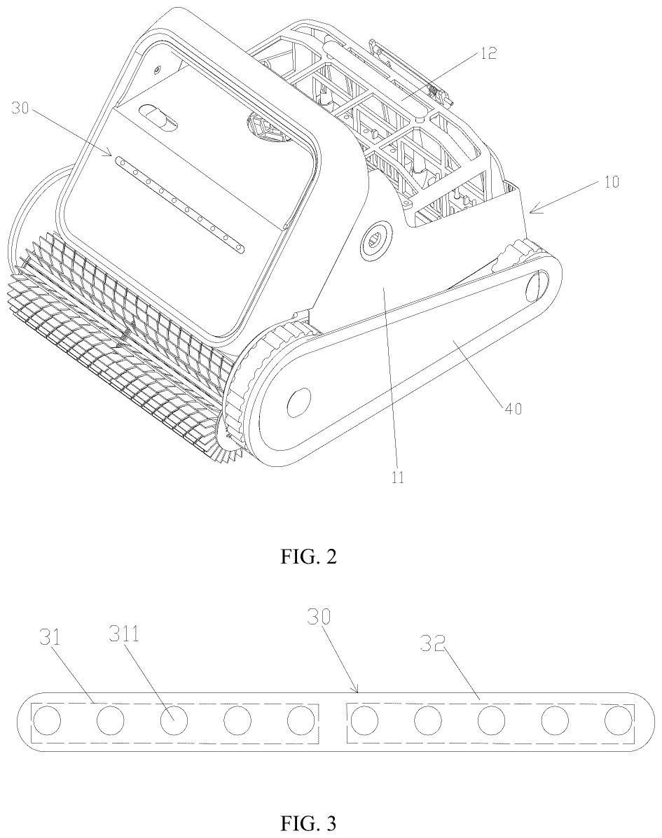

The cleaning member 10 is used for cleaning a pool. As shown in FIG. 1 and FIG. 3, the cleaning member 10 includes at least a first housing 11, a filter structure 12 and a driving mechanism. The first housing 11 has a water inlet 111 and a water outlet 112. The filter structure 12 is arranged between the water inlet 111 and the water outlet 112 and configured to filter contaminants in water entering from the water inlet 111, and the water outlet 112 is configured to discharge the filtered water.

The filter structure 12 may be a filter basket, and the filter basket covers the water inlet 111 to ensure that the water and contaminants entering the first housing 11 are filtered by the filter basket. In this way, cleaning effect is ensured, and it is also avoided that contaminants enter the first housing 11 through bypassing the filter basket, causing damage to other components of the pool cleaning robot.

In order to prevent water or contaminants from leaking from the water inlet 111, the water inlet 111 is provided with a one-way valve, so that water and contaminants can enter the first housing via the water inlet 111, but cannot flow out via the water inlet 111.

In addition to the filter structure 12, a sealed cavity 13 is also provided in the first housing 11. Electrical components of the pool cleaning robot are mounted in the sealed cavity 13, and the sealed cavity 13 is used for protecting these electrical components. The sealed cavity 13 includes a sealing housing 131, a water pump motor 132, a driving motor, a battery, and the like. The sealing housing 131 is arranged in the first housing 11. The battery is arranged in the sealing housing 131 and supplies power to the water pump motor 132, the driving motor, the detecting device, etc.

The water pump motor 132 is arranged in the sealing housing 131, and an output shaft of the water pump motor 132 extends out of the sealing housing 131. The output shaft of the water pump motor 132 is provided with an impeller 133, and the impeller 133 is configured to drive the water to flow.

The driving motor is used for driving the driving mechanism arranged on the first housing 11 and causing the driving mechanism to move, thereby driving the pool cleaning robot to move in the pool. The driving mechanism includes a driving wheel 22, a driven wheel 23 and a track (not shown). The driving wheel 22 is connected to the output shaft of the driving motor, and rotates by the driving of the output shaft. The driving wheel 22 rotates and drives the driven wheel 23 to move through the track.

The detecting device is arranged in the cleaning member 10. The detecting device is configured to detect state information of the cleaning member 10. The state information includes human-machine interaction state information and/or self-running state information of the cleaning member 10. The display device 30 is electrically connected to the detecting device, and configured to display at least one state information of the cleaning member 10, facilitating the user to view the state information, so that the user can know the state of the pool cleaning robot in time, and adjust the pool cleaning robot or deal with the fault in time.

For example, the detecting device is connected to the water pump motor 132 and detects the current of the water pump motor 132. The current is used for indicating a clogging degree of the filter structure 12. The current is taken as one of the self-running state information of the cleaning member 10. In this way, the display device 30 can display the clogging degree of the filter structure 12, so that when the clogging degree of the filter structure 12 is too high, the user can replace the filter structure 12 in time, so as to ensure the cleaning effect.

For another example, the detecting device is connected to the battery, and detects remaining power of the battery as one of the self-running state information. In this way, the display device 30 can display the remaining power of the battery, so that the user can know in time that the remaining power of the battery is insufficient, and control the pool cleaning robot to quickly move to place and stop or return for charging, thereby avoiding the pool cleaning robot from staying in the pool due to insufficient power.

For yet another example, the detecting device is connected to the driving motor, and detects a rotation speed and/or a rotation angle of the driving motor as one or more of the self-running state information of the cleaning member 10. The display device 30 may receive the rotation speed and/or the rotation angle from the detecting device, and then display the rotation speed and/or the rotation angle. The user may determine the moving speed of the pool cleaning robot based on the rotation speed, and then determine, according to the rotation speed, the cleaning mode of the pool cleaning robot such as a quick cleaning mode, a fine cleaning mode and so on. The rotation angle of the driving motor can indicate the rotation angle of the pool cleaning robot.

In one or more embodiments, in order to facilitate the detecting device to detect the rotation speed and/or rotation angle, an encoder is arranged for the output shaft of the driving motor. The detecting device is connected to the encoder, and determines the rotation speed and/or the rotation angle of the driving motor as one or more of the self-running state information of the cleaning member 10 according to an encoding signal output by the encoder. The rotation angle and/or rotation speed of the driving motor can be accurately detected through the encoder, and is of higher reliability.

In addition to the above state information, the self-running state information of the pool cleaning robot may also include at least one of: normal working state information, fault state information and component state information. The normal working state information is used for indicating that the pool cleaning robot is in a normal state in each operation stage. For example, the normal working state information can indicate that a power-on state of the pool cleaning robot is normal, a self-checking state is normal, a shutdown state is normal, a moving state is normal, and a cleaning state is normal, an obstacle avoidance state is normal, a moving-to-side state is normal, a return state is normal, etc.

The fault state information is used for indicating that the pool cleaning robot is in a fault state in a specific operation stage. For example, the fault state information may indicate that the power-on state of the pool cleaning robot is abnormal, the self-checking state is abnormal, the shutdown state is abnormal, the moving state is abnormal, and the cleaning state is abnormal, the obstacle avoidance state is abnormal, the moving-to-side state is abnormal, the return state is abnormal, etc.

The power level of the battery, the rotation speed, the rotation angle, the current of the water pump motor, etc. can belong to the component state information, but the component state information is not limited to this.

In addition to detecting the above self-running state information of the pool cleaning robot, the detecting device can also detect the human-machine interaction state information. The human-machine interaction state information may include: the state information obtained by the detection of the detecting device to the cleaning member according to an information command input by the user, but is not limited to this. The information command input by the user may include two aspects. One is the information that the user wants to query, such as cleaning progress, power level of the battery, and the like. If the user inputs an information command to display the power level of the battery to the pool cleaning robot, the pool cleaning robot can obtain the power level of the battery through the detecting device, and then can display the power level of the battery through the display device.

The other one is the state information in response to the user's input operation. For example, when the user inputs an operation to switch the cleaning mode, the pool cleaning robot switches the cleaning mode according to the user's operation, and the detecting device detects that the pool cleaning robot has switched the cleaning mode. The detected switched cleaning mode is used as the human-machine interaction state information, and the display device 30 displays the human-machine state interaction information.

In order to conveniently receive the information command input by the user, the pool cleaning robot may also include a receiving device, the receiving device is electrically connected to the detecting device, and the information command input by the user is received through the receiving device. The detecting device performs detection according to the information command, and then transmits the detection result to the display device 30 for displaying, thereby realizing the user's acquisition of the human-machine interaction state information.

In one or more embodiments, in order to facilitate display, the display device 30 includes at least one display unit for displaying at least one state information. For example, the display unit may be a display light strip, the display light strip can display one state information, or can display two or more state information at the same time.

For example, in one or more embodiments, the display unit includes a first display part 31 and a second display part 32. The first display part 31 and the second display part 32 can cooperate to display one state information. For example, the first display part 31 includes a plurality of display lights 311, which are arranged on the cleaning member 10 and are electrically connected to the detecting device. At least one of rightness or color of each of the plurality of display lights 311 is adjusted according to a signal received from the detecting device so as to display corresponding state information. The first display part 31 and the second display part 32 may be two parts logically divided and display the same state information cooperatively. For example, the first display part 31 and the second display part 32 display the battery level together.

As shown in FIG. 3, in one or more embodiments, the first display part 31 and the second display part 32 are configured to display different state information simultaneously. In this case, the first display part 31 and the second display part 32 may be two parts in logic or two parts physically divided, which are not limited, as long as different state information can be displayed simultaneously.

Exemplarily, the first display part 31 may include five display lights 311, and light-dark states of the five display lights 311 are used for displaying the battery level or the clogging degree of the filter structure 12. During the cleaning process, if the five display lights 311 of the first display part 31 are all turned on, it indicates that the battery power is sufficient or the filter structure 12 is least clogged. Later, the battery power is gradually consumed, or the filter structure 12 is slowly clogged, the display lights 311 are dimmed one by one until one display light 311 is left turned on. At this time, it indicates that the current state of the pool cleaning robot is that the battery power is insufficient or the filter structure 12 is seriously clogged, and the user is reminded that the pool cleaning robot needs to be charged or the filter structure 12 needs cleaning. In this way, the pool cleaning robot can work normally and affecting to the operation reliability of the pool cleaning robot is avoided.

Further, the light color of the display lights 311 can be used for further distinguishing the state information of the pool cleaning robot. For example, when the five display lights 311 are all on, the light colors of the five display lights 311 are set to green at the same time; and when only one display light 311 is left turned on, the light color of the turned-on display light 311 is set to red, so that the user can more easily find out that the pool cleaning robot is in poor working condition and adjust it in time.

In one or more embodiments, when only one display light 311 is left turned on, its lighting mode can also be set to flicker, which is easier to attract the user's attention.

In one or more embodiments, the display unit further includes a display screen. The display screen is arranged on the cleaning member 10. Alternatively, the display screen is arranged outside the pool and independent of the cleaning member and is in communication connection with the detecting device, and thus it is easier for user to view the state information of the pool cleaning robot on land, making the usage more convenient.

The current self-running state information and human-machine interaction state information of the cleaning member is indicated by display text information or image information on the display screen, so that user can more directly understand the state information of the pool cleaning robot.

Exemplarily, the battery level can be displayed in one of the following forms: numbers, percentages, energy bars, etc. Alternatively, the battery level can be displayed by a combination of one or more of the above forms. Alternatively, the above forms can be displayed in combination, which is not limited in the embodiments of the present application.

In one case, the display screen is movably arranged at a location away from the pool and is in communication with the detecting device. Exemplarily, the display screen can be arranged separately, and the display screen can be fixedly arranged at the poolside. With a detachable installation method, it is facilitated to move the display screen according to the needs of the user. Alternatively, the display screen of an electronic mobile device such as mobile phone and computer can be used. By communication connection between the above electronic mobile device and the detecting device, the state information of the pool cleaning robot can be displayed on the display screen of the electronic mobile device, making it more convenient for user to view.

In another case, the display screen is detachably arranged on the cleaning member 10 and is electrically connected to the detecting device. Exemplarily, the display screen can be fixed on the cleaning member 10 by bolts, which is easy to detach. The display screen can display the state information individually. Alternatively, the display screen and the display lights 311 may work cooperatively, and the display screen and the display lights 311 are arranged on the first display part 31 and the second display part 32 respectively, and thus different state information of the pool cleaning robot can be displayed at the same time. In addition, when one of the display screen and the display lights 311 fails, the other one can serve as a temporary backup, avoiding that the user cannot obtain the state information of the pool cleaning robot when the display device 30 fails.

In a specific implementation, the display device 30 may include a voice device, and the state information of the pool cleaning robot is indicated by voice broadcast information of the voice device. Exemplarily, the voice broadcast information can be set independently, or can be set in combination with the display screen or the display light 311. By indicating the state information of the pool cleaning robot through the voice broadcast information, the distance range for the user to obtain the state information of the pool cleaning robot can be expanded, so that it is more convenient for user to obtain the state information of the pool cleaning robot.

In one case, the voice device is movably arranged at a location away from the pool and is in communication with the detecting device to obtain state information from the detecting device. Exemplarily, the voice device may be provided at the poolside, and is electrically connected to the detecting device, so as to indicate the self-running state information and the human-machine interaction state information of the cleaning member 10 through the voice broadcast information of the voice device. It is also feasible to use the voice device of electronic mobile device such as mobile phone, computer, etc. By the communication connection between the above electronic mobile device with the detecting device, the state of the pool cleaning robot is indicated through the voice device of the electronic mobile device, so that the user can obtain the state information of the pool cleaning robot more convenient.

It should be understood that although the description herein is based on various embodiments, it is by no means the case that each embodiment contains just one independent technical solution. Such a method of presentation is adopted herein purely for the sake of clarity. Those skilled in the art should consider the description in its entirety. The technical solutions in the various embodiments could also be suitably combined to form other embodiments capable of being understood by those skilled in the art.

The detailed explanations set forth above are merely particular explanations of feasible embodiments of the present disclosure, which are not intended to limit the scope of protection thereof. All equivalent embodiments or changes made without departing from the artistic spirit of the present disclosure, such as combinations, divisions or repetitions of features, shall be included in the scope of protection of the present disclosure.

1. A pool cleaning robot with a display device, comprising:
a cleaning member (10) for cleaning a pool;
a detecting device, the detecting device being arranged in the cleaning member (10) and configured to detect a state of the cleaning member (10); and
a display device (30), the display device (30) being electrically connected to the detecting device and configured to display at least one state information of the cleaning member (10), the state information comprising human-machine interaction state information and/or self-running state information of the cleaning member (10).

2. The pool cleaning robot with a display device according to claim 1, wherein the cleaning member (10) comprises at least a first housing (11) and a filter structure (12), the first housing (11) has a water inlet (111) and a water outlet (112), the filter structure (12) is arranged between the water inlet (111) and the water outlet (112) and configured to filter contaminants in water entering from the water inlet (111), and the water outlet (112) is configured to discharge the filtered water.

3. The pool cleaning robot with a display device according to claim 2, wherein the cleaning member (10) further comprises a sealed cavity (13), the sealed cavity (13) comprises a sealing housing (131), the sealing housing (131) is arranged in the first housing (11), and the detecting device is arranged in the sealing housing (131);
a water pump motor (132) is provided in the sealing housing (131), an output shaft of the water pump motor (132) extends out of the sealing housing (131), and the output shaft of the water pump motor (132) is provided with an impeller (133) for driving water to flow; the detecting device is connected to the water pump motor (132), and configured to detect a current of the water pump motor (132), the current is used for indicating a clogging degree of the filter structure (12), and the current is one of the self-running state information of the cleaning member (10).

4. The pool cleaning robot with a display device according to claim 3, wherein a battery is arranged in the sealing housing (131), and the detecting device is connected to the battery and configured to detect remaining power of the battery as one of the self-running state information of the cleaning member (10).

5. The pool cleaning robot with a display device according to claim 3, wherein the first housing (11) is connected to a driving mechanism (40), a driving motor is provided in the sealed cavity (13), an output shaft of the driving motor extends out of the sealing housing (131) and is connected to the driving mechanism (40) so as to drive the driving mechanism (40) to move, and the detecting device is connected to the driving motor and configured to detect a rotation speed and/or a rotation angle of the driving motor as one or more of the self-running state information of the cleaning member (10).

6. The pool cleaning robot with a display device according to claim 5, wherein the output shaft of the driving motor is connected with an encoder, and the detecting device is connected to the encoder and configured to determine the rotation speed and/or the rotation angle of the driving motor as one or more of the self-running state information of the cleaning member (10) according to an encoding signal provided by the encoder.

7. The pool cleaning robot with a display device according to claim 1, wherein the display device (30) comprises at least a display unit, and the display unit is configured to display at least one state information.

8. The pool cleaning robot with a display device according to claim 2, wherein the display device (30) comprises at least a display unit, and the display unit is configured to display at least one state information.

9. The pool cleaning robot with a display device according to claim 3, wherein the display device (30) comprises at least a display unit, and the display unit is configured to display at least one state information.

10. The pool cleaning robot with a display device according to claim 4, wherein the display device (30) comprises at least a display unit, and the display unit is configured to display at least one state information.

11. The pool cleaning robot with a display device according to claim 5, wherein the display device (30) comprises at least a display unit, and the display unit is configured to display at least one state information.

12. The pool cleaning robot with a display device according to claim 6, wherein the display device (30) comprises at least a display unit, and the display unit is configured to display at least one state information.

13. The pool cleaning robot with a display device according to claim 1, wherein the display device (30) comprises at least one display unit, and the display unit comprises a first display part (31) and a second display part (32),
wherein the first display part (31) and the second display part (32) are configured to cooperate to display one state information, or the first display part (31) and the second display part (32) are configured to display different state information at the same time.

14. The pool cleaning robot with a display device according to claim 2, wherein the display device (30) comprises at least one display unit, and the display unit comprises a first display part (31) and a second display part (32),
wherein the first display part (31) and the second display part (32) are configured to cooperate to display one state information, or the first display part (31) and the second display part (32) are configured to display different state information at the same time.

15. The pool cleaning robot with a display device according to claim 3, wherein the display device (30) comprises at least one display unit, and the display unit comprises a first display part (31) and a second display part (32),
wherein the first display part (31) and the second display part (32) are configured to cooperate to display one state information, or the first display part (31) and the second display part (32) are configured to display different state information at the same time.

16. The pool cleaning robot with a display device according to claim 4, wherein the display device (30) comprises at least one display unit, and the display unit comprises a first display part (31) and a second display part (32),
wherein the first display part (31) and the second display part (32) are configured to cooperate to display one state information, or the first display part (31) and the second display part (32) are configured to display different state information at the same time.

17. The pool cleaning robot with a display device according to claim 5, wherein the display device (30) comprises at least one display unit, and the display unit comprises a first display part (31) and a second display part (32),
wherein the first display part (31) and the second display part (32) are configured to cooperate to display one state information, or the first display part (31) and the second display part (32) are configured to display different state information at the same time.

18. The pool cleaning robot with a display device according to claim 6, wherein the display device (30) comprises at least one display unit, and the display unit comprises a first display part (31) and a second display part (32),
wherein the first display part (31) and the second display part (32) are configured to cooperate to display one state information, or the first display part (31) and the second display part (32) are configured to display different state information at the same time.

19. The pool cleaning robot with a display device according to claim 13, wherein the first display part (31) comprises a plurality of display lights (311), the plurality of display lights (311) are arranged on the cleaning member (10) and electrically connected to the detecting device, and at least one of rightness or color of each of the plurality of display lights (311) is adjusted according to a signal received from the detecting device so as to display corresponding state information.

20. The pool cleaning robot with a display device according to claim 19, wherein the display unit further comprises a display screen, the display screen is arranged on the cleaning member (10), or the display screen is arranged outside a pool independently of the cleaning member and is in communication connection with the detecting device.
